(19) United States
(12) Patent Application Publication
(10) Pub. No.: US 2013/0108366 A1
(43) Pub. Date: May 2, 2013

(54) SPREADING DEVICE, PARTICULARLY FOR SPREADING CHIPPINGS

(71) Applicant: Hamm AG, Tirschenreuth (DE)

(72) Inventors: Detlef Bornemann, Leonberg (DE); Mirco Marth, Bad Alexandersbad (DE); Peter Preisinger, Tirschenreuth (DE); Dieter Hamann, Konnersreuth (DE)

(73) Assignee: HAMM AG, Tirschenreuth (DE)

(21) Appl. No.: 13/661,259

(22) Filed: Oct. 26, 2012

(30) Foreign Application Priority Data
Oct. 26, 2011 (DE) 102011085241.7

(51) Int. Cl. E01C 19/20; B05C 19/00; E01C 19/22

(52) U.S. Cl. 404/103; 239/650

(57) ABSTRACT

A spreading device, particularly for applying chippings, comprising a chippings reservoir with an arrangement for discharge openings to discharge chippings downwards, with at least one deflection plate being arranged underneath the arrangement for discharge openings aligned diagonal in reference to a vertical direction.

The present invention relates to a spreading device, by which granular and/or particulate material can be applied on an underground. For example, such a spreading device may be used in order to apply chippings in one of the last processing steps when producing asphalt surfaces and then integrating them in the section near the surface via a compressing device, i.e. for example a ground compactor. By providing chippings in the area close to the surface the road grip for vehicles traveling thereon can be increased. It is also possible for such a device to apply chippings or perhaps salt in wintry conditions. Another application is to spread granular or particulate material, such as fertilizer or seeds in agriculture.

In general, various types of spreading devices can be distinguished. In spreading devices with a rotating spreading disk the material to be spread is applied from the top onto the rotating spreading disk, perhaps comprising conveyer blades. The chippings are accelerated by the conveyer blades in the circumferential direction. By the centrifugal forces developing here the chippings are thrown radially towards the outside and thus spread on the underground. While a relatively wide spreading width can be achieved with such a design, considerably exceeding the width of the spreading device per se and/or the vehicle comprising the spreading device, a homogenous spreading image cannot be achieved, as is particularly required when applying chippings on the surface of an asphalt coating. In a different design of a spreading device a discharge opening for the chippings is provided at the bottom of a chippings reservoir, for example oblong like a slot. The chippings are discharged through this opening towards the bottom, whereby inside the chippings reservoir perhaps conveyance devices may be provided, such as fan-like conveyance wheels, by which a defined adjustment is possible of the amount of chippings discharged through the openings for the chippings. Using such a design a more homogenous chippings image can be generated, although the spreading width is limited essentially to the width of the spreading device and the chippings reservoir, respectively.

The objective of the invention is to provide a spreading device, particularly for applying chippings, by which a more homogenous application of the material to be spread can be achieved.

According to the invention this objective is attained in a spreading device, particularly for applying chippings, comprising a chippings reservoir with an arrangement for discharge openings to release chippings towards the bottom, with at least one deflection plate being arranged underneath the arrangement for discharge openings aligned diagonal in reference to the vertical direction.

The present invention generally uses a design with a chippings reservoir and an arrangement for discharge openings through which chippings can be released downwards onto the underground to be coated, thus not using a rotating spreading disk or the like. Due to the fact that according to the invention a deflection plate is arranged underneath the arrangement for discharge openings, aligned diagonally, the chippings discharged through the arrangement for discharge openings do not fall directly upon the underground but first onto the deflection plate, whereby after impinging the deflection plate by the diagonal positioning thereof the chippings are moved accordingly diagonally downwards over the surface of the deflection plate. During this motion, simultaneously the spreading of the chippings released is rendered more homogenous in the longitudinal direction of the arrangement for discharge openings such that a considerably more homogenous spreading image is yielded with a very even distribution of the chippings on the underground to be coated.

In order to allow an area of the underground as large as possible to be coated it is suggested in this design that the arrangement for discharge openings and at least one deflection plate are oblong in the direction of the longitudinal direction of the opening.

As explained above, the present invention uses the effect that any chippings impinging the deflection plate move towards the bottom not only along the deflection plate but are also distributed perpendicularly in reference to this direction of motion. This effect can additionally be used to expand the spreading width. According to the invention it may be provided, for this purpose that at least in the end section of the opening of the arrangement for discharge openings located in the longitudinal direction of the opening the deflection plate extends beyond the arrangement of discharge openings in the longitudinal direction of said opening.

In an advantageous design it may further be provided that the arrangement for discharge openings comprises a plurality of discharge openings, successive in the longitudinal direction of the openings. A plurality of discharge openings leads, with a high degree of homogeneity of the distribution of the chippings discharged, to a stable design with a simple way to influence the amount of chippings discharged.

For the simple and yet stable fastening of at least one deflection plate it is suggested that in an area located lateral in reference to the longitudinal direction of the openings next to the arrangement for discharge openings at least one deflection plate is provided in a fastening edge region at the chippings reservoir and extends diagonally downwards from said fastening edge region.

In order to ensure that essentially all the chippings discharged downwards through the arrangement for discharge openings in the direction of at least one deflection plate impinge said deflection plate and can be distributed thereby it is suggested that at least one deflection plate extends entirely over the arrangement for discharge openings perpendicular in reference to the longitudinal direction of the discharge openings.

In order to allow using at least one deflection plate to accept and evenly distribute the chippings to be discharged as efficiently as possible it is suggested for the deflection plate to be positioned underneath the arrangement for discharge openings with a section in the vertical direction closer to the fastening edge region.

In a simple and also cost-effectively realized embodiment at least one deflection plate may be produced from sheet metal. In order to increase its stability it is further suggested that at least one deflection plate is curved in a discharge edge region and/or at least one facial edge region.

Another essential influence to yield increased homogeneity in the distribution of the chippings can be achieved such that at least one deflection plate is embodied at least sectionally like a sieve with a plurality of penetrating openings for the chippings. Advantageously here, at least one deflection plate is embodied like a sieve over its entire area accepting the chippings wherein further advantageously the cross-sectional size of the penetrating openings for the chippings is to be adjusted to the chippings to be discharged such that even the largest particles expected can pass through these penetrating openings for chippings. By providing such sieve-like structures it is ensured that some chippings and/or not all chippings move diagonally downwards along at least one deflection plate to reach a discharge edge region and here trickle down, and already during the traveling process in the direction diagonally downwards successively particles of chippings pass through the penetrating discharge openings and thus only a relatively small portion of the chippings is discharged via the discharge edge region of at least one deflection plate downwards towards the underground. This further means that by providing the deflection plate not only an improved distribution occurs perpendicular in reference to the longitudinal direction of the opening, but additionally a distribution is possible in the direction of motion of the particulate chippings diagonally downwards.

The invention further relates to a self-moving compacting device, particularly a ground compactor with a spreading device designed according to the invention.

In the following the invention is described in greater detail with reference to the attached figures. It shows:

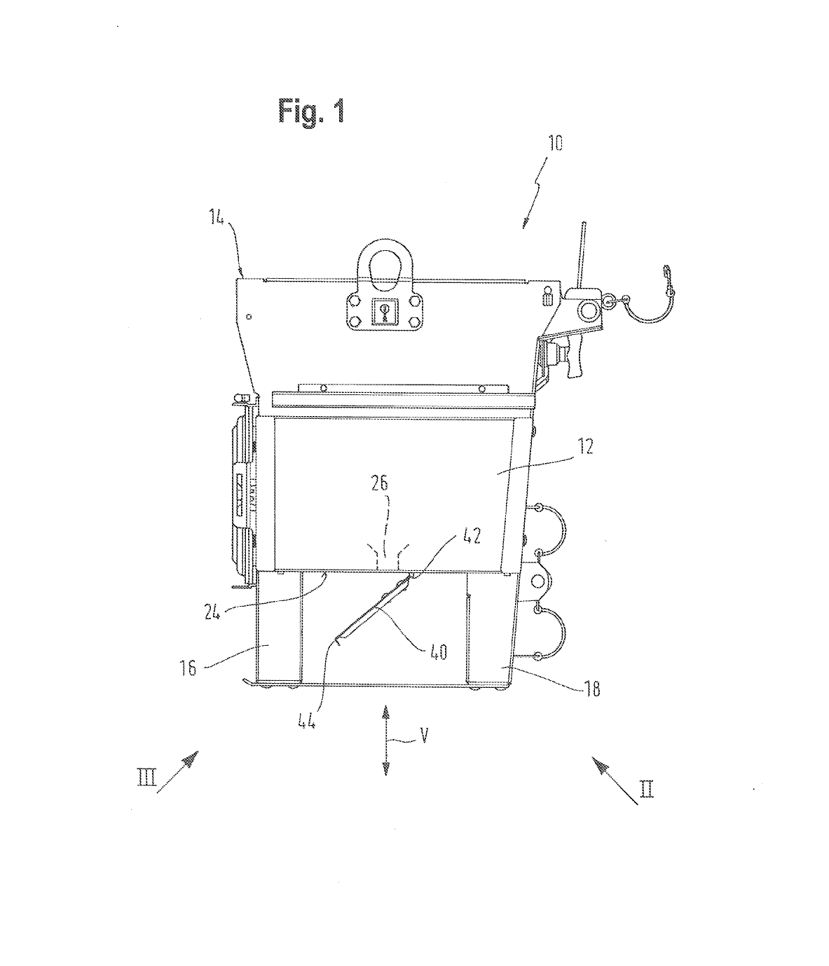

FIG. 1 a side view of a spreading device;

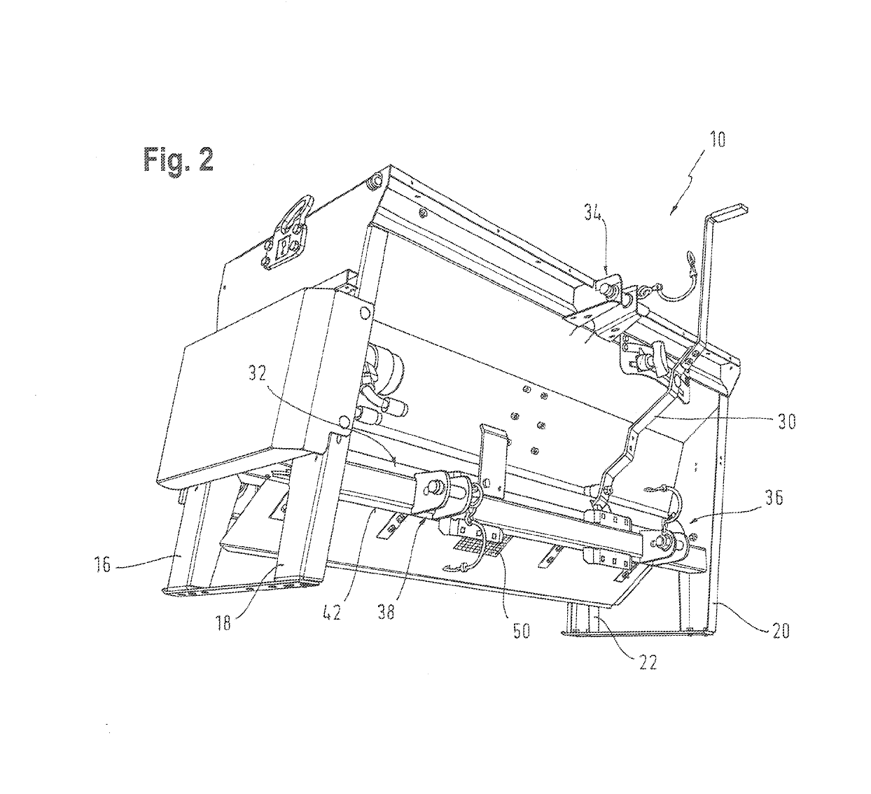

FIG. 2 a perspective view of the spreading device of FIG. 1 seen diagonally from the bottom in the direction of view II in FIG. 1;

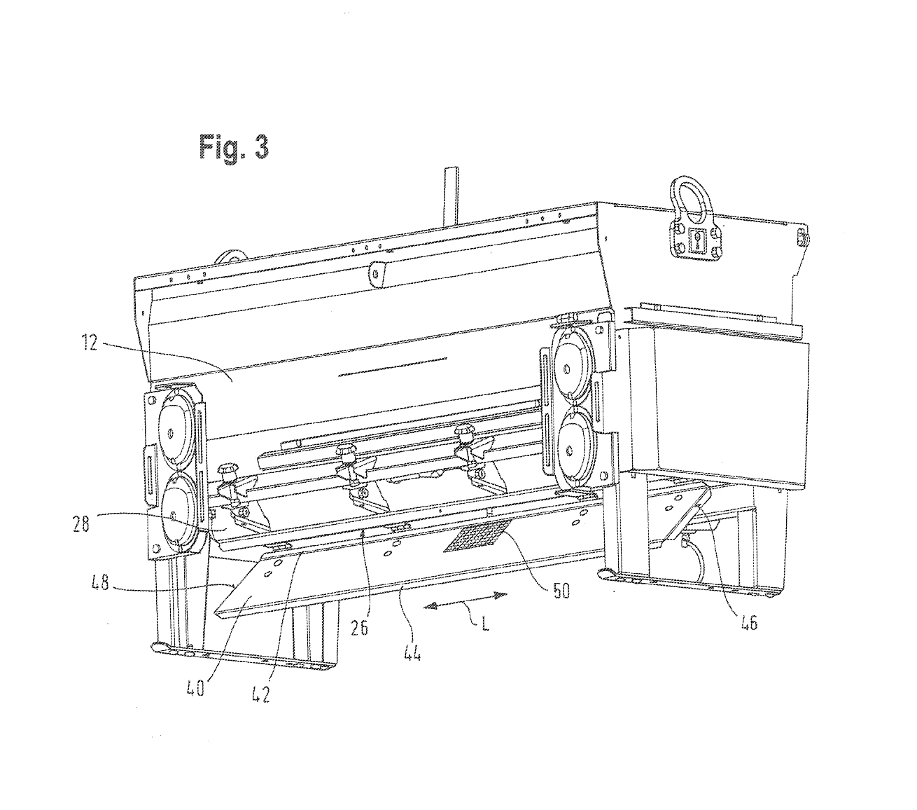

FIG. 3 a perspective view of the spreading device of FIG. 1 seen diagonally from the bottom in the direction of view III in FIG. 1.

The spreading device 10 shown in FIGS. 1 to 3 comprises a chippings reservoir marked 12 in its entirety. This may be widened like a funnel towards its top 14 and open in order to allow introducing the chippings to be applied on the underground from the top into the chippings reservoir 12. For example, at the chippings reservoir 12 support legs 16, 18, 20, 22 may be provided in the four corner sections in order to allow placing the spreading device 10 on the ground, for example when it is not in operation.

An arrangement for chippings discharge openings 26 is arranged at the bottom 24 of the chippings reservoir 12, which is shown symbolically in dot-dash lines in FIG. 1. This arrangement for discharge openings 26 may comprise a continuous discharge opening, however preferably it comprises a plurality of discharge openings, and is oblong in a longitudinal direction of openings L, which is aligned perpendicular in reference to the drawing level in FIG. 1 and is essentially equivalent to the width of the spreading device 10. Inside the chippings reservoir 12 various conveyance devices may be provided, e.g. fan blades, which ensure during the spreading operation that the chippings contained inside the chippings reservoir 12 are conveyed downwards in a defined amount in the direction towards the arrangement for discharge openings 26. Here, gravity alone affecting the chippings may be used, too. Furthermore, the cross-sectional opening of the discharge opening(s) may be variable by a slider.

Using a service hatch 28 discernible in FIG. 3, access can be granted to the inside of the chippings reservoir 12 in the bottom section. At the bottom 24 in the area of the arrangement for discharge openings 26 a slider 32, discernible in FIG. 2, can be adjusted and/or displaced, for example by a manually adjustable operating mechanism 30, for example in order to change the opening cross-section of the arrangement for discharge openings 26 and thus be able to influence the amount of chippings discharged. Further, various fastening sections 34, 36, 38 are discernible in FIG. 2, in which the spreading device 10 can be fastened to a vehicle, thus for example a ground compactor, a winter service vehicle or a tractor or the like.

In the exemplary embodiment shown, in the vertical direction V, underneath the arrangement for discharge openings 26, a deflection plate 40 is arranged, continuous, i.e. not interrupted in the longitudinal direction of the openings L. This is fastened in a fastening edge region 42, for example by a plurality of fastening brackets 43, fixed at the chippings reservoir 12, at the bottom 24 of the chippings reservoir 12 and extends diagonally downwards starting from the fastening edge region 42 in the direction towards the discharge edge region 44. Here, it must be pointed out that the fastening edge region 42 and the discharge edge region 44, in the oblong embodiment of the deflection plate 40 particularly discernible in FIG. 2, respectively form long lateral edge regions of the deflection plate 40. The facial edge regions 46, 48 of the deflection plate 40, thus the respectively shorter edge regions in oblong embodiments, are each arranged in the longitudinal opening direction L of the arrangement for discharge openings 26, with preferably the design being such that the deflection plate 40 in the longitudinal direction of the opening L exceeds the arrangement for discharge openings 26, thus extends beyond the end sections of the openings, for example by a length of 5 to 10 cm.

As discernible in FIGS. 2 and 3, in a central area of the deflection plate 40, it may be provided with a plurality of penetrating openings 50 for chippings, thus embodied like a sieve in general, wherein here it must be pointed out that these sieve-like configurations in the illustrations are only limited to a section for easier display, preferably however such sieve-like configurations are embodied over the entire deflection plate 40. The size of the penetrating openings 50 for chippings is here adjusted to the chippings to be applied such that advantageously even the largest, at least the majority of particulate chippings can pass through these penetrating openings for the chippings.

Due to the fact that the deflection plate 40 advantageously is made from sheet metal, in order to increase its stability it may be provided that particularly the edge regions connected to the chippings reservoir 12, thus the two facial edge regions 46, 48 and also the discharge edge region 44, are curved, thus for example bent, thus achieving reinforcement in these edge regions.

The chippings, discharged from the arrangement for discharge openings 26 in the vertical direction V downwards, advantageously impinge a deflection plate 40 in a surface area closer to the fastening edge region 42. By the diagonal alignment of the deflection plate 40 the chippings move over its surface diagonally downwards in the direction towards the discharge edge region 44. During this motion diagonally downwards a more even distribution of the chippings is achieved and/or promoted laterally in reference to the direction of motion, thus in the longitudinal direction L of the openings. While traveling in the direction towards the discharge edge region 44 successively individual particulate chippings will pass through the penetrating openings 50 for the chippings and impinge the underground to be coated underneath the deflection plate 40. This means that in the comparatively narrow range of width of the deflection plate 40, which is essentially equivalent to the width of the discharge opening 26 for chippings, any chippings impinging the deflection plate 40 reach the underground surface area equivalent to a projected width of the diagonally aligned deflection plate 40 so that not only a more homogenous distribution is achieved over the longitudinal direction of the openings but also perpendicular in reference to the longitudinal direction of the openings. This is supported of course such that when discharging the chippings the device 10 will generally move essentially perpendicular in reference to the longitudinal direction of the opening L and also perpendicular in reference to the vertical direction V. Only those particulate chippings which during the motion towards the discharge edge region 44 could not pass through the penetrating openings for chippings will fall downwards at the discharge edge section 44 and here spread by the forward motion of the spreading device 10 on the underground to be coated.

Due to the fact that furthermore the deflection plate is advantageously formed such in the longitudinal direction of the openings, in both end sections, thus where the lateral edge regions 46, 48 are formed, that it projects beyond the arrangement for discharge openings 26 and/or the end sections of the opening by the effect that chippings impinging the deflection plate 40 are also spread in the longitudinal direction L of the openings, in addition to a more homogenous spreading image, an enlarged spreading width is achieved as well.

Of course, using various technical measures in the context of the present invention the spreading behavior and thus also the spreading image achievable can be influenced, here. For example, the sizing and/or the positioning of the penetrating openings 50 of the chippings are of essential influence for the spreading behavior. The number of penetrating openings 50 for chippings per area unit as well as their size and distribution can also be predetermined based on the requirements of the spreading image to be achieved. Further it is possible, for example, that the density or/and the size of the penetrating openings for chippings in the direction of the fastening edge region 42 towards the discharge edge region 44 vary, if applicable also in the direction towards the facial edge regions 46, 48. For example, in the proximity of the fastening edge region 42 the size and/or the area density of the penetrating openings 50 for the chippings may be smaller than near the discharge edge region 44, whereby here for example an essentially steady increase may be given with regard to size and/or area density. Here, the increase in area density of the penetrating openings of chippings may coincide with an increase of the overall penetrating surface per area unit of the deflection plate 40 provided for the chippings.

Of course it is not mandatorily required to fasten the deflection plate 40 at the chippings reservoir 12 in a stiff fashion. Here, a pivotal fastening is also possible with the option to adjust the angle in reference to the vertical direction V, thus also allowing the influencing of the spreading image. Furthermore, it is possible of course to divide the deflection plate 40 into a plurality of individual plates, perhaps independently adjustable in their alignment, thus for example to provide several such deflection plates successively in the longitudinal direction L of the openings underneath the arrangement for discharge openings 26. It is of course possible that at least the deflection plate 40 can be fastened at its fastening edge region at the chippings reservoir 12 such that it is fastened at the plate-shaped components of the chippings reservoir 12 encompassing the accepted volume of chippings or its stabilizing or reinforcing carriers or frame elements in a stiff or perhaps also pivotal fashion.

The projection of the deflection plate 40 beyond the opening edge regions of the arrangement for discharge openings 26 may be adjusted according to the given requirements. When combining the spreading device according to the invention with a ground compactor it is advantageous to select a length for the deflection plate 40 which is essentially adjusted to the width of the lining, thus the roller width of a roller and/or roller arrangement integrating the discharged chippings in the underground. For this purpose it is possible to waive the chippings displacement devices and to simplify the process of integrating the chippings in the area of an asphalt coating near the surface.

1. A spreading device, particularly for applying chippings, comprising a chippings reservoir with an arrangement for discharge openings to discharge chippings downwards, with at least one deflection plate being arranged underneath the arrangement for discharge openings aligned diagonal in reference to a vertical direction.

2. A spreading device according to claim 1,
characterized in that the arrangement for discharge openings and at least one deflection plate extend in a longitudinal direction of the openings.

3. A spreading device according to claim 2,
characterized in that at least in an opening end section of the arrangement for discharge openings located in the longitudinal direction of openings at least one deflection plate extends in the longitudinal direction of openings beyond the arrangement for discharge openings.

4. A spreading device according to claim 2,
characterized in that the arrangement for discharge openings comprises a plurality of discharge openings successive in the longitudinal direction of openings.

5. A spreading device according to claim 2,
characterized in that in an area located next to the arrangement for discharge openings laterally in reference to the longitudinal direction of openings at least one deflection plate is fastened in a fastening edge region at the chippings reservoir and extends from the fastening edge region diagonally downwards.

6. A spreading device according to claim 5,
characterized in that at least one deflection plate entirely covers the arrangement for discharge openings perpendicular in reference to the longitudinal direction of openings.

7. A spreading device according to claim 6,
characterized in that the deflection plate is positioned with a fastening edge section being closer in the vertical direction under the arrangement for discharge openings.

8. A spreading device according to claim 1,
characterized in that at least one deflection plate is curved in a discharge edge region or/and at least in a facial edge region.

9. A spreading device according to claim 1,
characterized in that at least one deflection plate is formed at least sectionally in a sieve-like fashion with a plurality of penetrating openings for chippings.

10. A self-moving compacting device, particularly a ground compactor, comprising the spreading device according to one of the previous claims.
